(19) United States
(12) Patent Application Publication
(10) Pub. No.: US 2011/0273487 A1
(43) Pub. Date: Nov. 10, 2011

(54) LIQUID CRYSTAL DISPLAY MODULE, LIQUID CRYSTAL DISPLAY DEVICE, MOBILE DEVICE, AND METHOD OF DRIVING LIQUID CRYSTAL DISPLAY MODULE

(76) Inventor: Ken Inda, Osaka-shi (JP)

(21) Appl. No.: 13/138,075

(22) PCT Filed: Nov. 19, 2009
(86) PCT No.: PCT/JP2009/069621

§ 371 Date: Jun. 30, 2011

(30) Foreign Application Priority Data
Apr. 30, 2009 (JP) 2009-110482

(51) Int. Cl. G09G 5/10

(52) U.S. Cl. 345/690; 345/88

(57) ABSTRACT

At least one embodiment of the present invention provides a liquid crystal display module which can achieve low power consumption and high display quality without generating tearing. In at least one embodiment, the liquid crystal display module includes: a gate driver for driving a plurality of pixels per color of a plurality of primary colors different from each other, the plurality of pixels including pixels of the plurality of primary colors so that each of the plurality of primary colors is displayed by pixels of the each of the plurality of primary colors; a plurality of light sources for emitting different kinds of light, respectively, which different kinds of light correspond to the plurality of primary colors, respectively; and an LED driving circuit for controlling the plurality of light sources so that, during a time period in one frame, in which time period pixels of one of the plurality of primary colors are driven by the gate driver so as to display the one of the plurality of primary colors, at least one of the different kinds of light, other than a kind of light corresponding to the one of the plurality of primary colors, is emitted.

### TECHNICAL FIELD

The present invention relates to a liquid crystal display module of an active matrix liquid crystal display device, a liquid crystal display device, a mobile device, and a method of driving a liquid crystal display module, for example.

BACKGROUND ART

A liquid crystal display device including a liquid crystal display module has been widely used in recent years because it has advantages such as a thin and light-weight body and a low consumption current. An active matrix liquid crystal display device in which a plurality of switching elements are provided for respective pixels which are arranged in matrix can provide a high-quality video image. For this reason, the active matrix liquid crystal display device is now widely used in particular.

Such a liquid crystal display device including the liquid crystal display module has a problem of generation of so-called tearing, which is a phenomenon in which scanning of a plurality of pixels is displayed (see FIG. 6). That is, it is necessary for a liquid crystal display device to scan the plurality of pixels to display a screen. During a course of the scanning, for example, a state where writing is being carrying out but not completed, like a state illustrated in (b) of FIG. 6, is displayed on the screen when the screen is switched over from a screen illustrated in (a) of FIG. 6 to a screen illustrated in (c) of FIG. 6. Such tearing occurs when image data of a next frame is inputted when image data of a current frame has not been completely displayed yet. Thus, in the tearing, two or more sorts of image data are displayed in a single screen. Accordingly, there is a reduction in display quality of the liquid crystal display device.

In recent years, it has been a common object for such a liquid crystal display device including the liquid crystal module to (i) prevent generation of tearing and simultaneously (ii) reduce a consumption current.

Patent Literature 1 discloses a method in which (i) a backlight is off while image data is being written and (ii) the backlight is turned on after the writing of the image data is completed. Specifically, in an R field, a light emitting diode for R is turned on after image data for R is written (see FIG. 7). Similarly, in a G field, a light emitting diode for G is turned on after image data for G is written, and in a B field, a light emitting diode for B is turned on after image data for B is written. This prevents new image data (next image data) from being written on current image data before the current image data written in a frame memory is read out from the frame memory. With the method disclosed in Patent Literature 1, the generation of tearing is thus prevented.

Further, according to Patent Literature 2, generation of flickers and generation of tearing are prevented in such a manner that (i) it is determined whether an input image is a moving image or a still image and then (ii) a refresh rate of an output image is set in accordance with the determination.

Furthermore, according to Patent Literature 3, the generation of tearing is prevented by changing a logical memory structure of an image memory in accordance with inputted image data.

### Citation List

Patent Literature

Patent Literature 1

Japanese Patent Application Publication, Tokukai, No. 2006-154750 A (Publication Date: Jun. 15, 2006)

Patent Literature 2

Japanese Patent Application Publication, Tokukai, No. 2006-98765 A (Publication Date: Apr. 13, 2006)

Patent Literature 3

Japanese Patent Application Publication, Tokukai, No. 2004-252102 A (Publication Date: Sep. 9, 2004)

### SUMMARY OF INVENTION

### Technical Problem

However, the methods described in Patent Literatures 1 through 3 have the following problems. According to the method disclosed in Patent Literature 1, the backlight is off while image data is being written, and then the backlight is turned on after the writing of the image data is completed. For this reason, it is necessary to separately provide a writing time period and a backlight illumination time period (see FIG. 7). Accordingly, both the writing time period and the backlight illumination time period become short.

In a case where the writing time period is short, it is necessary to set a relatively-high frequency. This increases power consumption. Further, in a case where the backlight illumination time period is short, luminance of a liquid crystal display device becomes low. This causes a reduction in display quality.

According to either the method described in Patent Literature 2 or the method described in Patent Literature 3, the generation of tearing can be prevented, but there is an increase in power consumption due to necessity of changing a setting in accordance with an input image.

The present invention is made in view of the problems. An object of the present invention is to provide a liquid crystal display module, a liquid crystal display device, a mobile device, and a method of driving a liquid crystal display module, each of which can achieve low power consumption and high display quality without generation of tearing.

### Solution to Problem

In order to attain the object, a liquid crystal display module of the present invention, includes: an active matrix liquid crystal display panel in which a plurality of pixels including pixels of a plurality of primary colors different from each other are provided so that each of the plurality of primary colors is displayed by pixels of the each of the plurality of primary colors; a liquid crystal driving circuit for driving the plurality of pixels per color of the plurality of primary colors; a plurality of light sources for emitting different kinds of light, respectively, which different kinds of light correspond to the plurality of primary colors, respectively; and a light source driving circuit for controlling the plurality of light sources so that, during a time period in one frame, in which time period pixels of one of the plurality of primary colors are driven by the liquid crystal driving circuit so as to display the one of the plurality of primary colors, at least one of the different kinds of light, other than a kind of light corresponding to the one of the plurality of primary colors, is emitted.

According to the arrangement, the liquid crystal display module of the present invention includes: the liquid crystal driving circuit for driving the plurality of pixels; the plurality of light sources for emitting the different kinds of light, respectively; and the light source driving circuit for controlling the plurality of light sources. Further, the light source driving circuit controls the plurality of light sources so that, during a time period in one frame, in which time period pixels of one of the plurality of primary colors are driven by the liquid crystal driving circuit to display the one of the plurality of primary colors, at least one of the different kinds of light, other than the kind of light corresponding to the one of the plurality of primary colors, is emitted.

Since the kind of light corresponding to the one of the plurality of primary colors is not emitted during the time period in which the pixels of the one of the plurality of primary colors are driven to display the one of the plurality of primary colors, a state where the writing is being carried out but is not completed is not displayed on a screen. That is, it is possible to prevent generation of tearing. Further, there is always at least one light source which is on, out of the plurality of light sources, while the liquid crystal display module is in operation. Therefore, a change in luminance in the screen can be suppressed. Accordingly, generation of fine flickers in the screen can be suppressed. Further, since a lighting time period of each of the light sources is long, it is possible to suppress a current flowing the light source. Therefore, it is possible to achieve lower power consumption.

Further, there are always at least pixels of one primary color, to which the writing is being carried out, out of the pixels of the plurality of primary colors, while the liquid crystal display module is in operation. Accordingly, it is possible to secure a sufficient writing time period for the pixels of each of the plurality of primary colors. Since the sufficient writing time period can be secured, it is possible to set a lower frequency. Therefore, it is possible to achieve lower power consumption. Further, since the sufficient writing time period can be secured, it is possible to maintain high display quality even with the use of liquid crystal whose response speed is slow.

In order to attain the object, a method of the present invention, for driving a liquid crystal display module including an active matrix liquid crystal display panel in which a. plurality of pixels including pixels of a plurality of primary colors different from each other are provided so that each of the plurality of primary colors is displayed by pixels of the each of the plurality of primary colors, includes the step of: emitting, during a time period in one frame, in which time period pixels of one of the plurality of primary colors are driven by the liquid crystal driving circuit so as to display the one of the plurality of primary colors, at least one of the different kinds of light, other than a kind of light corresponding to the one of the plurality of primary colors.

According to the arrangement, it is possible to achieve effects similar to those of the liquid crystal display module of the present invention.

Further, a liquid crystal display device including the liquid crystal display module and a mobile device including the liquid crystal display device are encompassed in the scope of the present invention.

Additional objects, features, and strengths of the present invention will be made clear by the description below. Further, the advantages of the present invention will be evident from the following explanation in reference to the drawings.

### Advantageous Effects of Invention

A liquid crystal display module of the present invention includes: an active matrix liquid crystal display panel in which a plurality of pixels including pixels of a plurality of primary colors different from each other are provided so that each of the plurality of primary colors is displayed by pixels of the each of the plurality of primary colors; a liquid crystal driving circuit for driving the plurality of pixels per color of the plurality of primary colors; a plurality of light sources for emitting different kinds of light, respectively, which different kinds of light correspond to the plurality of primary colors, respectively; and a light source driving circuit for controlling the plurality of light sources so that, during a time period in one frame, in which time period pixels of one of the plurality of primary colors are driven by the liquid crystal driving circuit to display the one of the plurality of primary colors, at least one of the different kinds of light, other than a kind of light corresponding to the one of the plurality of primary colors, is emitted. Therefore, it is possible to achieve low power consumption and high display quality without generation of tearing.

Further, a method of the present invention, for driving a liquid crystal display module including an active matrix liquid crystal display panel in which a plurality of pixels including pixels of a plurality of primary colors different from each other are provided so that each of the plurality of primary colors is displayed by pixels of the each of the plurality of primary colors, includes the step of: emitting, during a time period in one frame, in which time period pixels of one of the plurality of primary colors are driven by the liquid crystal driving circuit to display the one of the plurality of primary colors, at least one of the different kinds of light, other than a kind of light corresponding to the one of the plurality of primary colors. Therefore, it is possible to achieve low power consumption and high display quality without generation of tearing.

### BRIEF DESCRIPTION OF DRAWINGS

FIG. 1 is a view illustrating an arrangement of a liquid crystal display module in accordance with one embodiment of the present invention.

FIG. 2 is a timing chart showing how a liquid crystal display module operates in accordance with one embodiment of the present invention.

FIG. 3 is a view for explaining how to prevent generation of tearing in accordance with one embodiment of the present invention.

FIG. 4 is a view for explaining how to display a color image by a liquid crystal display module in accordance with one embodiment of the present invention.

FIG. 5 is a view illustrating an arrangement of a plurality of LEDs in a liquid crystal display module in accordance with one embodiment of the present invention.

FIG. 6 is a view for explaining how tearing is generated with a conventional technique.

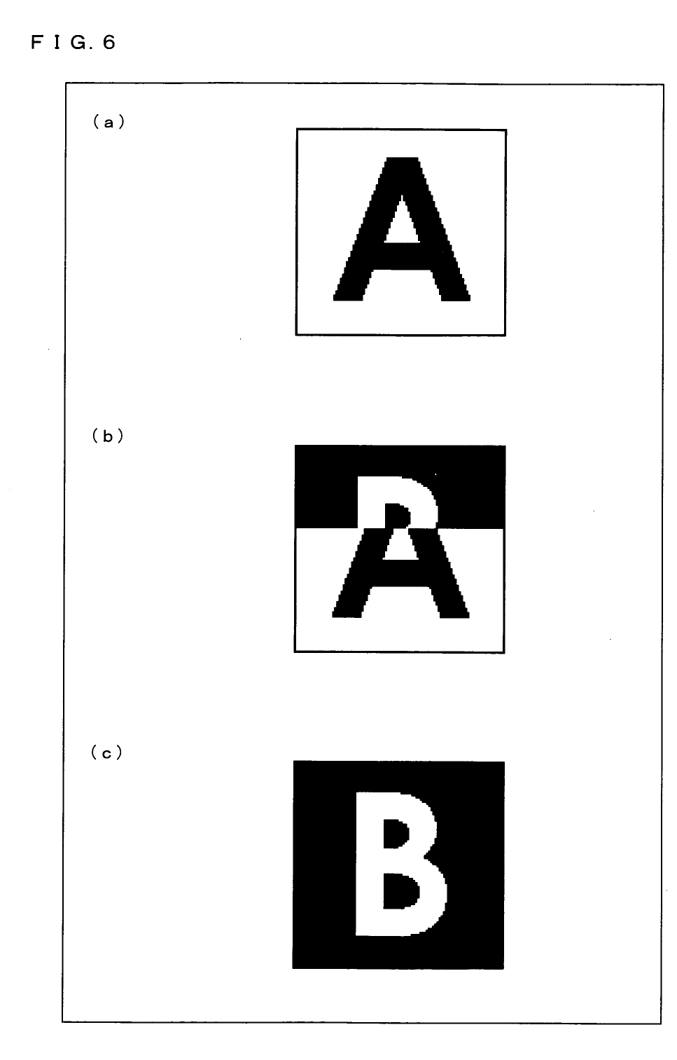

FIG. 7 is a timing chart showing how a liquid crystal display module operates in accordance with a conventional technique.

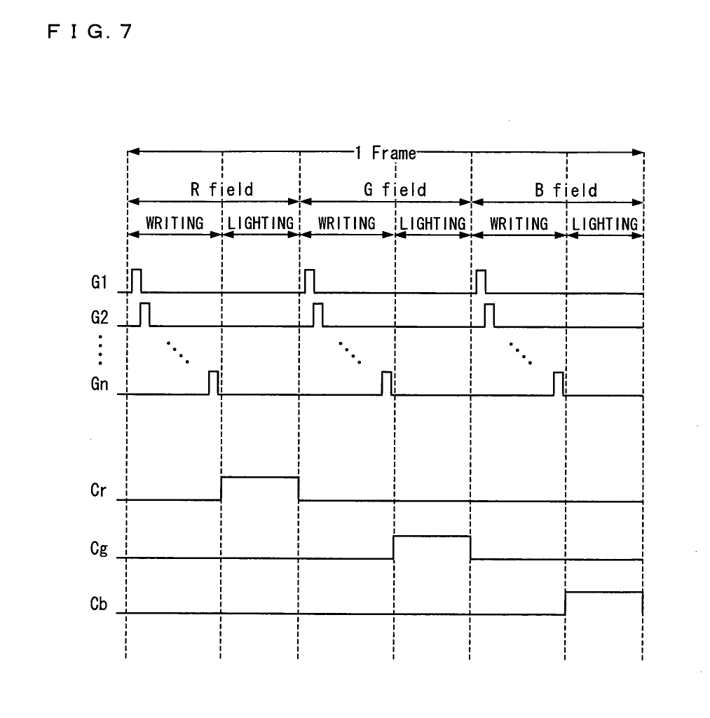

### DESCRIPTION OF EMBODIMENTS

### Embodiment 1

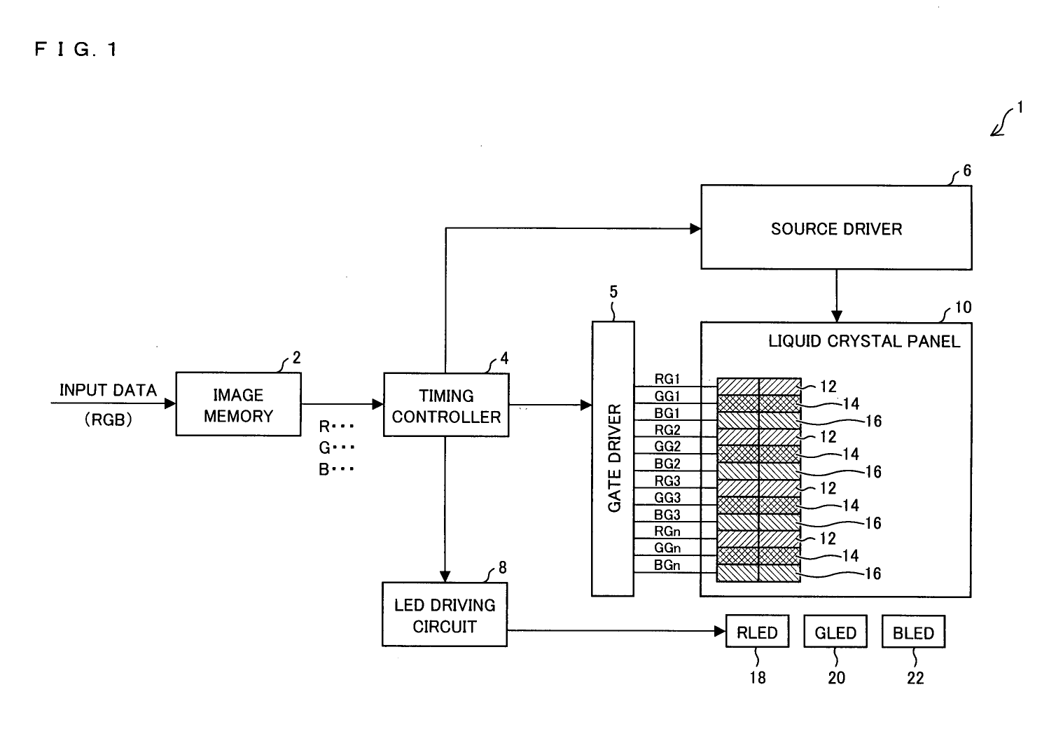

One embodiment of the present invention is described below with reference to FIGS. 1 through 5.

(Configuration of liquid crystal display module 1)

First, the following description deals with a configuration of a liquid crystal display module 1 of the present embodiment with reference to FIG. 1. FIG. 1 is a view illustrating the configuration of the liquid crystal display module 1. The liquid crystal display module 1 includes an image memory 2, a timing controller 4, a gate driver 5, a source driver 6, an LED driving circuit (light source driving circuit) 8, an active matrix liquid crystal panel 10, an R LED 18 (light source), a G LED 20 (light source), and a B LED 22 (light source) (see FIG. 1). Note that the gate driver 5 and the source driver 6 constitute a liquid crystal driving circuit (liquid crystal driver). Further, an R pixel 12 for displaying a red color, a G pixel 14 for displaying a green color, and a B pixel 16 for displaying a blue color are provided at each of intersections between a plurality of gate bus lines and a plurality of source bus lines in the liquid crystal panel 10. A plurality of R pixels 12, a plurality of G pixels 14, and a plurality of B pixels 16 are arranged so as to serve as a single display region (not illustrated) of the liquid crystal panel 10.

Further, the colors described here are primary colors. According to the present embodiment, the primary colors are red (R), green (G), and blue (B). However, the three primary colors are not limited to red, green, and blue. Further, the number of primary colors is not limited to three, provided that the plurality of primary colors are in a complementary relationship with one another. Such an arrangement is also encompassed in the scope of the present invention.

The gate driver 5 supplies gate signals to the respective plurality of gate bus lines so as to scan the display region. The source driver 6 supplies source signals to the respective plurality of source bus lines.

A gate signal supplied from the gate driver 5 to a corresponding one of the plurality of gate bus lines is inputted into pixels (one sort of the R pixel 12, the G pixel 14, and the B pixel 16) which share that gate bus line to which they are connected. With the arrangement, it is possible to drive, by use of gate signals, per gate bus line, each of the following (i) through (iii): (i) the plurality of R pixels 12, (ii) the plurality of G pixels 14, and (iii) the plurality of B pixels 16. Each of the plurality of R pixels 12 is connected to a corresponding one of gate bus lines RG1 through RGn for driving the plurality of R pixels 12. Similarly, each of the plurality of G pixels 14 is connected to a corresponding one of a plurality of gate bus lines GG1 through GGn for driving the plurality of G pixels 14, and each of the plurality of B pixels 16 is connected to a corresponding one of a plurality of gate bus lines BG1 through BGn for driving the plurality of B pixels 16. Note that “n” is an integer not less than 4.

(How liquid crystal display module 1 displays image)

Next, the following description deals with how the liquid crystal display module 1 displays an image. First, input data (RGB data) for displaying an image is supplied to the image memory 2 from the outside. The image memory 2 divides the input data into R data, G data, and B data, and supplies the R data, the G data, and the B data to the timing controller 4. The timing controller 4 processes each of the R data, the G data, and the B data, in accordance with an operational condition of the liquid crystal panel 10, so as to generate (i) a liquid crystal driving signal and (ii) a light source control signal.

Next, the timing controller 4 supplies the liquid crystal driving signal thus generated to the gate driver 5 and the source driver 6 (liquid crystal driving circuit). At predetermined timing in accordance with the liquid crystal driving signal, (i) the gate driver 5 (liquid crystal driving circuit) drives the plurality of gate bus lines in the liquid crystal panel 10, and (ii) the source driver 6 (liquid crystal driving circuit) drives the plurality of source bus lines in the liquid crystal panel 10.

Further, the timing controller 4 supplies the light source control signal thus generated to the LED driving circuit 8. The LED driving circuit 8 drives each of the R LED 18, the G LED 20, and the B LED 22, in accordance with the light source control signal. With the arrangement, the R LED 18, the G LED 20, and the B LED 22 are caused to emit their light at their predetermined timing.

The liquid crystal display module 1, first, drives the gate bus lines RG1 through RGn connected to the plurality of R pixels 12. Immediately after completion of writing with respect to the plurality of R pixels 12 (that is, immediately after a writing time period for the plurality of R pixels 12 elapses), the R LED 18 is turned on. This causes the plurality of R pixels 12 in the liquid crystal display panel 10 to display a red color in accordance with the writing. Further, the liquid crystal display module 1 drives the gate bus lines GG1 through GGn connected to the plurality of G pixels 14. Immediately after completion of writing with respect to the plurality of G pixels 14 is finished (that is, immediately after a wiring time period for the plurality of G pixels 14 elapses), the G LED 20 is turned on. This causes the plurality of G pixels 14 in the liquid crystal display panel 10 to display a green color in accordance with the writing. Similarly, the liquid crystal display module 1 drives the gate bus lines BG1 through BGn connected to the plurality of B pixels 16. Immediately after completion of writing with respect to the plurality of B pixels 16 is finished (that is, immediately after a writing time period for the plurality of B pixels 16 elapses), the B LED 22 is turned on. This causes the plurality of B pixels 16 in the liquid crystal display panel 10 to display a blue color in accordance with the writing.

Various colors are obtained by combinations of the three primary colors of red, green, and blue thus displayed. The liquid crystal panel 10 displays an image by taking advantage of an afterimage effect of viewer's eyes. According to the present embodiment, LEDs are used as the light sources. Note, however, that the present invention is not limited to this. Any light sources, including LEDs, can be employed, provided that the light sources can emit different kinds of light, independently, which different kinds of light correspond to a plurality of primary colors, respectively.

(Operation of liquid crystal display module 1)

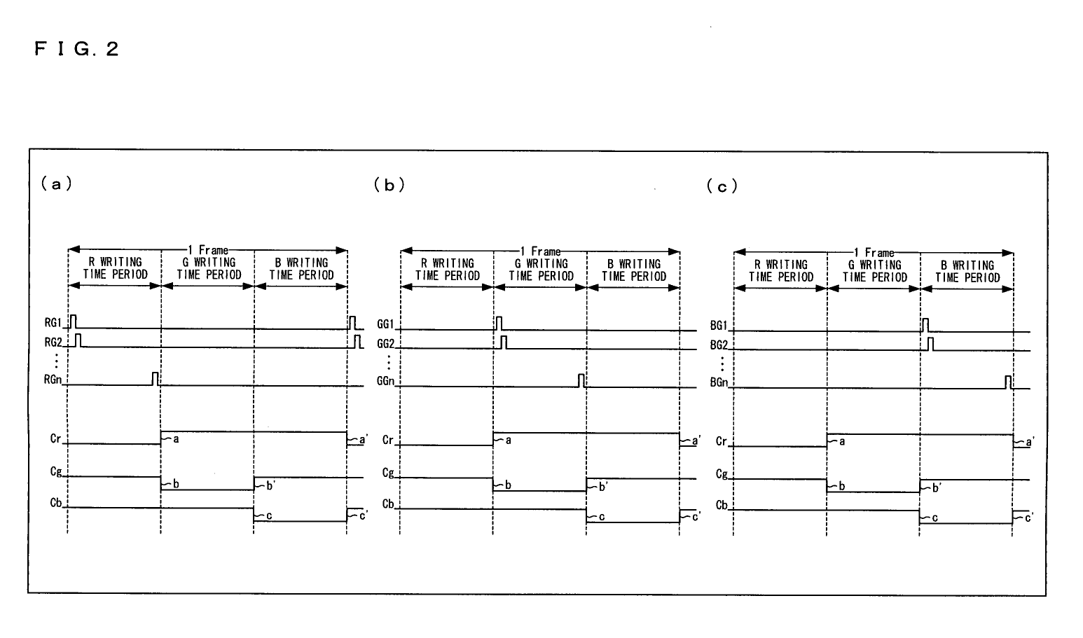

Next, the following description deals with how the liquid crystal display module 1 operates with reference to FIG. 2. Each of (a) through (c) of FIG. 2 is a timing chart showing how the liquid crystal display module 1 operates. In each of (a) through (c) of FIG. 2, “R writing time period” in one frame is a time period during which the writing is carried out with respect to the plurality of R pixels 12. Similarly, “G writing time period” in one frame is a time period during which the wiring is carried out with respect to the plurality of G pixels 14, and “B writing time period” in one frame is a time period during which the writing is carried out with respect to the plurality of B pixels 16. The gate bus lines RG1 through RGn, shown in (a) of FIG. 2, are gate bus lines each of which is connected to corresponding ones of the plurality of R pixels 12. Similarly, the gate bus lines GG1 through GGn, shown in (b) of FIG. 2, are gate bus lines each of which is connected to corresponding ones of the plurality of G pixels 14, and the gate bus lines BG1 through BGn, shown in (c) of FIG. 2, are gate bus lines each of which is connected to corresponding ones of the plurality of B pixels 16.

The gate bus lines RG1 through RGn are sequentially scanned in an order from the gate bus line RG1 to the gate bus line RGn during the R writing time period (see (a) of FIG. 2). Similarly, the gate bus lines GG1 through GGn are sequentially scanned in an order from the gate bus line GG1 to the gate bus line GGn during the G writing time period (see (b) of FIG. 2), and the gate bus lines BG1 through BGn are sequentially scanned in an order from the gate bus line BG1 to the gate bus line BGn during the B writing time period (see (c) of FIG. 2). Further, in each of (a) through (c) of FIG. 2, “Cr” is a lighting signal for instructing lighting of the R LED 18. Similarly, “Cg” is a lighting signal for instructing lighting of the G LED 20, and “Cb” is a lighting signal for instructing lighting of the B LED 22.

In the liquid crystal display module 1, during the R writing time period shown in (a) of FIG. 2, the lighting signal Cr is switched to an OFF state so as to turn off the R LED 18. During the R writing period, the gate bus lines RG1 through RGn connected to the plurality of R pixels 12 are driven so as to carry out the writing with respect to the plurality of R pixels 12. Meanwhile, during the R writing time period, the lighting signal Cg and the lighting signal Cb are switched to an ON state so as to turn on the G LED 20 and the B LED 22. After that, when the writing with respect to the plurality of R pixels 12 is completed, the lighting signal Cr is switched to the ON state (as indicated by “a” of FIG. 2), and the lighting signal Cg is switched to the OFF state (as indicated by “b” of FIG. 2). Accordingly, the G LED 20 is off and the R LED 18 and the B LED 22 are on, during the G writing time period shown in (b) of FIG. 2, during which the gate bus lines GG1 through GGn connected to the plurality of G pixels 14 are driven so as to carry out the writing with respect to of the plurality of G pixels 14. When the R LED 18 is turned on, the plurality of R pixels 12 to which the writing has been carried out during the R writing time period can display a red color in accordance with the writing.

When the writing with respect to the G pixels 14 is completed, the lighting signal Cg is switched to the ON state (as indicated by “b′” of FIG. 2), and the lighting signal Cb is switched to the OFF state (as indicated by of FIG. 2). Accordingly, the B LED 22 is off and the R LED 18 and the G LED 20 are on, during the B writing time period shown in (c) of FIG. 2, during which the gate bus lines BG1 through BGn connected to the plurality of B pixels 16 are driven so as to carry out the writing with respect to the plurality of B pixels 16. When the G LED 20 is turned on, the plurality of G pixels 14 to which the writing has been carried out during the G writing time period can display a green color in accordance with the writing. Upon completion of the writing with respect to the plurality of B pixels 16, the lighting signal Cr is switched to the OFF state (as indicated by “a′ ” of FIG. 2), and the lighting signal Cb is switched to the ON state (as indicated by “c′ ” of FIG. 2). Accordingly, the R LED 18 is off, and the G LED 20 and the B LED 22 are on during the R writing time period of a next frame. When the B LED 22 is turned on in the next frame, the plurality of B pixels 16 to which the writing has been carried out during the B writing time period can display a blue color in accordance with the writing.

Here, the following description schematically explains a problem of a general liquid crystal display module. In a general liquid crystal display module, a backlight is usually kept to be on. Therefore, it is impossible to hide the state where the scanning is being carried out and is not completed yet, as described above.. This generates tearing.

On the other hand, in the liquid crystal display module 1 of the present invention, the LED driving circuit controls the LEDs (R LED 18, G LED 20, B LED 22) so that while the gate driver 5 and the source driver 6 drive, in one frame, pixels for displaying one of the plurality of primary colors, light corresponding to at least one of the other primary colors among the plurality of primary colors is emitted. Here, “light corresponding to one of the primary colors” is light with which a pixel for displaying the one of the primary colors is suitably illuminated. Typically, such light has the same primary color as the primary color which is displayed by the pixel. For example, as light of the backlight, red light is emitted to the pixels for displaying a red color, blue light is emitted to the pixels for displaying a blue color, and green light is emitted to the pixels for displaying a green color.

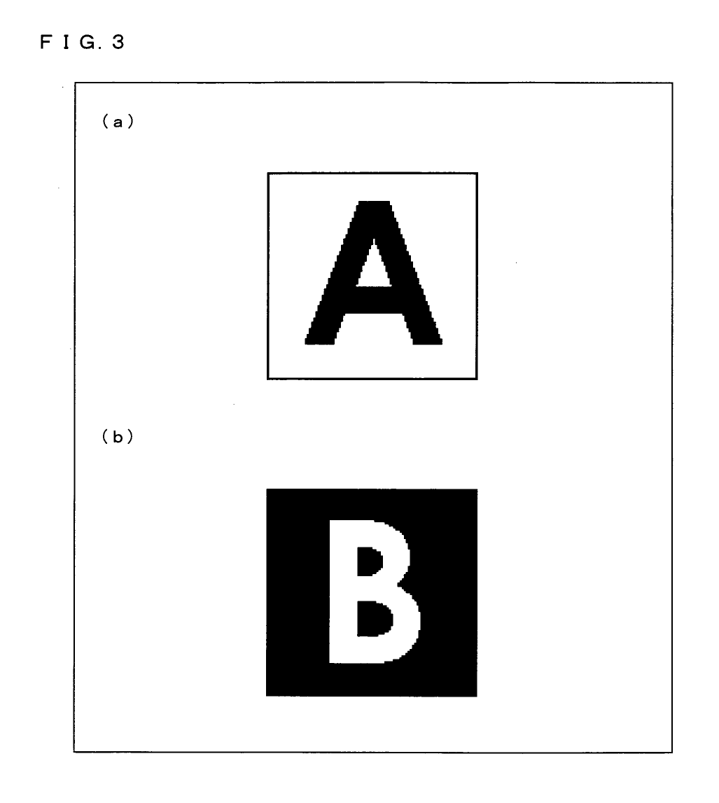

According to the liquid crystal display module 1, the R LED 18 is off while the writing is carried out with respect to the plurality of R pixels 12. Therefore, it is possible to prevent generation of tearing which is a phenomenon in which a state where the writing is being carried out and is not completed yet is displayed on a screen. Similarly, the G LED 20 is off while the writing is carried out with respect to the plurality of G pixels 14. Further, the B LED 22 is off while the writing is carried out with respect to the plurality of B pixels 16. With the arrangements, it is also possible to prevent the generation of tearing. That is, as illustrated in FIG. 3, a display of the liquid crystal display module 1 can smoothly change from a state shown in (a) of FIG. 3 to a state shown in (b) of FIG. 3, for example.

Further, the G LED 20 and the B LED 22 are on while the writing is carried out with respect to the plurality of R pixels 12. Similarly, the R LED 18 and the B LED 22 are on while the writing is carried out with respect to the plurality of G pixels 14, and the R LED 18 and the G LED 20 are on while the writing is carried out with respect to the plurality of B pixels 16. That is, there are always two LEDs which are on, out of the R LED 18, the G LED 20, and the B LED 22, while the liquid crystal display module 1 is in operation. This makes it possible to (i) provide liquid crystal having a relatively-high luminance and therefore (ii) maintain display quality. Further, since there are always two LEDs which are on, out of the R LED 18, the G LED 20, and the B LED 22, while the liquid crystal display module is in operation, colors are displayed two by two. This prevents generation of color aberration and the like.

Further, since there are always two LEDs which are on, out of the R LED 18, the G LED 20, and the B LED 22, while the liquid crystal display module 1 is in operation, a change in luminance in the screen can be suppressed. This can suppress generation of fine flickers on the display. Further, since a lighting time period of each of the R LED 18, the G LED 20, and the G LED 22 is long, it is possible to suppress a current flowing through the LED. Furthermore, each of the R LED 18, the G LED 20, and the B LED 22 is not frequently turned on/off, it is possible to have a reduction in power consumption.

Moreover, there are always pixels of one color, to which the writing is being carried out, out of (i) the plurality of R pixels 12, (ii) the plurality of G pixels 14, or (iii) the plurality of B pixels 16, while the liquid crystal display module 1 is in operation. Therefore, it is possible to ensure a sufficient writing time period for the plurality of pixels. With the sufficient writing time period, it is possible to set a lower frequency. Therefore, it is possible to have a reduction in power consumption. Further, since the writing time period can be secured sufficiently, it is possible to maintain high display quality even with the use of liquid crystal whose response speed is slow.

Further, in the liquid crystal display module 1 in accordance with the present embodiment, there are always two LEDs which are on, out of the R LED 18, the G LED 20, and the B LED 22, during any one of the writing time periods for (i) the plurality of R pixels 12, (ii) the plurality of G pixels 14, and (iii) the plurality of B pixels 16. However, the present invention is not limited to this. It is possible to achieve effects similar to those of the aforementioned arrangement in such a manner that there is only one LED which is on, out of the R LED 18, the G LED 20, and the B LED 22, during any one of the writing time periods for (i) the plurality of R pixels 12, (ii) the plurality of G pixels 14, and (iii) the plurality of B pixels 16. For example, one of the G LED 20 and the B LED 22 is set so that the one of the G LED 20 and the B LED 22 is on while the writing is being carried out with respect to the plurality of R pixels 12.

Meanwhile, in a case where the liquid crystal display module 1 deals with not less than four primary colors, i.e., in a case where the liquid crystal display module 1 includes not less than four LEDs corresponding to the above primary colors, such LEDs can be controlled so that all light is emitted except light having a color corresponding to a color of the pixels to which the writing is being carried. In this case, it is possible for the liquid crystal display panel to have a higher luminance. Further, since a lighting time period of each of the LEDs is long, it is possible to suppress a current flowing the LED as much as possible. Therefore, it is possible to reduce power consumption as much as possible.

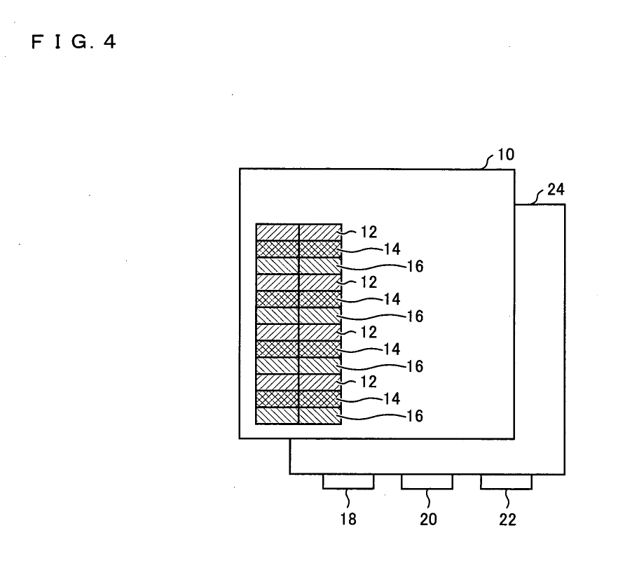

Next, the following description deals with how the liquid crystal display module 1 displays a color image with reference to FIG. 4. The liquid crystal display module 1 employs a color filter so as to display a color image. As early described, the liquid crystal display module 1 includes LEDs for R, G, and B colors. Further, the liquid crystal panel 10 has a color filter layer of three primary colors, namely, red (R), green (G), and blue (B).

Light emitted from each of the R, G, B LEDs can pass through only a color filter corresponding to the color of that LED. For example, light emitted from the R LED 18 can pass through only an R color filter. Similarly, light emitted from the G LED 20 can pass through only a G color filter, and light emitted from the B LED 22 can pass through only a B color filter. The light passing through each color filter is adjusted in amount by control of a voltage applied to the liquid crystal of the liquid crystal panel 10, so as to combine colors with one another. In this manner, a desired image is displayed.

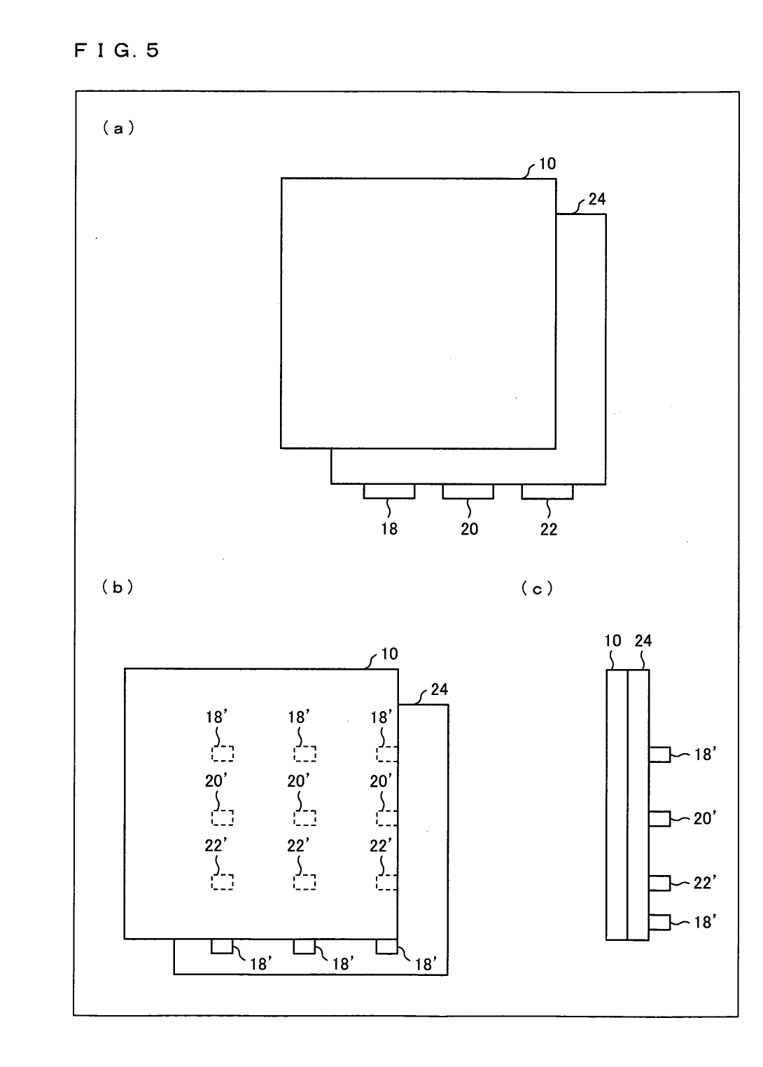

Next, the following description deals with an arrangement of the plurality of R LEDs, the plurality of G LEDs, and the plurality of B LEDs in the liquid crystal display module 1, with reference to FIG. 5. The liquid crystal display module 1 can be a so-called edge-light-type module in which (i) light emitted from each of the R LED 18, the G LED 20, and the B LED 22 is led into a light guide plate 24, and (ii) an entire surface of the light guide plate 24 emits light uniformly (see (a) of FIG. 5). Alternatively, the liquid crystal display module 1 can be a so-called direct-type module in which a plurality of R LEDs 18′, a plurality of G LEDs 20′, and a plurality of B LEDs 22′ are provided all over the surface of the light guide plate (see (b) of FIG. 5). (c) of FIG. 5 is a cross-sectional view of (b) of FIG. 5. As illustrated in (c) of FIG. 5, the plurality of R pixels 18′, the plurality of G pixels 20′, and the plurality of B pixels 22′ are provided on the light guide plate 24. As described above, the liquid crystal module 1 can be either an edge-light-type module or a direct-type module.

Further, a liquid crystal display device including the liquid crystal display module, and a mobile device including the liquid crystal display device are also encompassed in the scope of the present invention.

The liquid crystal display module of the present invention is preferably arranged such that the light source driving circuit carries out the controlling so that a plurality of kinds of light out of the different kinds of light, other than the kind of light corresponding to the one of the plurality of primary colors, are emitted.

According to the arrangement, the light source driving circuit controls the plurality of light sources so that a plurality of kinds of light out of the different kinds of light, other than the kind of light corresponding to the one of the plurality of primary colors, are emitted. Since the plurality of light sources emit plurality of kinds of light, the liquid crystal display panel has a higher luminance. Further, since a lighting time period of each of the plurality of light sources becomes longer, it is possible to suppress a current flowing in the light source. Accordingly, it becomes possible to achieve lower power consumption more efficiently.

The liquid crystal display module of the present invention is preferably arranged such that the light source driving circuit carries out the controlling so that all of the different kinds of light, except the kind of light corresponding to the one of the plurality of primary colors, are emitted.

According to the arrangement, the light source driving circuit controls the plurality of light sources so that all of the different kinds of light, except the kind of light corresponding to the one of the plurality of primary colors, are emitted. Accordingly, the liquid crystal display panel can have an increase in luminance as much as possible. Further, since the lighting time period of each of the plurality of light sources becomes long as much as possible, it is possible to suppress the current flowing in the light source as much as possible. Therefore, it becomes possible to reduce power consumption as much as possible.

The liquid crystal display module of the preset invention is preferably arranged such that the light source driving circuit carries out the controlling so that the kind of light corresponding to the one of the plurality of primary colors is emitted immediately after the liquid crystal driving circuit finishes the driving of the pixels of the one of the plurality of primary colors.

According to the arrangement, the light source driving circuit controls the plurality of light sources so that the kind of light corresponding to the one of the plurality of primary colors is emitted immediately after the liquid crystal driving circuit finishes the driving of the pixels of the one of the plurality of primary colors. Accordingly, it is possible to cause the liquid crystal display panel to display an image by taking advantage of an afterimage effect of viewer's eyes.

The liquid crystal display module of the present invention is preferably arranged such that the plurality of primary colors are three primary colors of red, blue, and green.

According to the arrangement, the liquid crystal display module can cause the liquid crystal display panel to display an image by use of pixels for displaying general three primary colors, namely, red, blue, and green. Further, it becomes possible to use generally-used red, blue, green LEDs as the plurality of light sources.

The liquid crystal display module of the present invention is preferably arranged such that the plurality of light sources are direct-type light sources or edge-light-type light sources.

According to the arrangement, it is possible to use direct-type light sources or edge-light-type light sources, as the plurality of light sources of the liquid crystal display module.

(Additional matters)

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### Industrial Applicability

A liquid crystal display module of the present invention is widely applicable to a general display device including a liquid crystal module employing an active matrix liquid crystal display panel.

Reference Signs List
1: Liquid crystal display module
2: Image memory
4: Timing controller
5: Gate driver (liquid crystal driving circuit)
6: Source driver (liquid crystal driving circuit)
8: LED driving circuit (light source driving circuit)
10: Liquid crystal panel
12: R pixel (pixel)
14: G pixel (pixel)
16: B pixel (pixel)
18: R LED (light source)
20: G LED (light source)
22: B LED (light source)
24: Light guide plate

1. A liquid crystal display module comprising:
an active matrix liquid crystal display panel in which a plurality of pixels including pixels of a plurality of primary colors different from each other are provided so that each of the plurality of primary colors is displayed by pixels of the each of the plurality of primary colors;
a liquid crystal driving circuit for driving the plurality of pixels per color of the plurality of primary colors;
a plurality of light sources for emitting different kinds of light, respectively, which different kinds of light correspond to the plurality of primary colors, respectively; and
a light source driving circuit for controlling the plurality of light sources so that, during a time period in one frame, in which time period pixels of one of the plurality of primary colors are driven by the liquid crystal driving circuit so as to display the one of the plurality of primary colors, at least one of the different kinds of light, other than a kind of light corresponding to the one of the plurality of primary colors, is emitted.

2. The liquid crystal display module as set forth in claim 1, wherein:
the light source driving circuit carries out said controlling so that a plurality of kinds of light out of the different kinds of light, other than the kind of light corresponding to the one of the plurality of primary colors, are emitted.

3. The liquid crystal display module as set forth in claim 2, wherein:
the light source driving circuit carries out said controlling so that all of the different kinds of light, except the kind of light corresponding to the one of the plurality of primary colors, are emitted.

4. The liquid crystal display module as set forth in claim 1, wherein:
the light source driving circuit carries out said controlling so that the kind of light corresponding to the one of the plurality of primary colors is emitted immediately after the liquid crystal driving circuit finishes the driving of the pixels of the one of the plurality of primary colors.

5. The liquid crystal display module as set forth in claim 1, wherein:
the plurality of primary colors are three primary colors of red, blue, and green.

6. The liquid crystal display module as set forth in claim 1, wherein:
the plurality of light sources are direct-type light sources or edge-light-type light sources.

7. A liquid crystal display device, comprising:
a liquid crystal display module recited in claim 1.

8. A mobile device comprising:
a liquid crystal display device recited in claim 7.

9. A method of driving a liquid crystal display module including an active matrix liquid crystal display panel in which a plurality of pixels including pixels of a plurality of primary colors different from each other are provided so that each of the plurality of primary colors is displayed by pixels of the each of the plurality of primary colors, the method comprising the step of:
emitting, during a time period in one frame, in which time period pixels of one of the plurality of primary colors are driven by the liquid crystal driving circuit so as to display the one of the plurality of primary colors, at least one of the different kinds of light, other than a kind of light corresponding to the one of the plurality of primary colors.
